(19) United States
(12) Patent Application Publication
(10) Pub. No.: US 2019/0139461 A1
(43) Pub. Date: May 9, 2019

(54) APPARATUS FOR SIGNALING A ROADSIDE EMERGENCY

(71) Applicant: David Christopher Dennis Lester, Aldergrove (CA)

(72) Inventor: David Christopher Dennis Lester, Aldergrove (CA)

(21) Appl. No.: 15/898,409

(22) Filed: Feb. 16, 2018

Related U.S. Application Data
(63) Continuation-in-part of application No. 15/804,205, filed on Nov. 6, 2017.

(51) Int. Cl. G09F 7/18; E01F 9/662

(52) U.S. Cl. CPC G09F 7/18; G09F 2007/1852; G09F 2007/1865; E01F 9/662

(57) ABSTRACT

An apparatus for signaling a roadside emergency includes a plurality of panels including a first-panel, a second-panel, and a third-panel, a plurality of markings, and a plurality of attachment means. The second-panel and third-panel include words to alert other drivers and emergency service. The plurality of markings are disposed about a surface area of the plurality of panels to provide a visual indicator. The plurality of attachment means are configured to attach the plurality of panels to a vehicle. The apparatus may be used to signal the roadside emergency by providing a highly visible safety sign or banner for applying to a vehicle.

### CROSS-REFERENCE TO RELATED APPLICATION(S)

The present application is a Continuation-in-Part and is related to and claims priority to U.S. Non-Provisional patent application Ser. No. 15/804,205 filed Nov. 6, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of signs and banners and more specifically relates to traffic warning signs.

### 2. Description of Related Art

Travel on interstate highways requires that automobiles travel at a relatively high rate of speed. It is often necessary that the driver of a vehicle on such a highway be alert for unexpected occurrences on the roadway ahead. One type of unexpected occurrence is the disabled vehicle along the side of the highway, or in some cases, in the middle of the high speed lane of the roadway. It is not always possible for the driver of an oncoming vehicle to discern whether the vehicle on the shoulder is moving or standing still, until he realizes that he is approaching the vehicle at a relatively fast closing rate. Thus, he is forced to maneuver at the last minute, since he could not determine the state of the vehicle in time for a judicious lane change. Also, at high rates of speed, it is difficult for the passing motorist to tell whether the driver of the stopped vehicle is merely resting or in need of help. Therefore, it would be desirable to have a distress warning device which unmistakably indicates to oncoming traffic that a distress condition exists, so that such oncoming traffic can have sufficient time to take corrective action and obtain help when necessary. A suitable solution is desired.

U.S. Pat. No. 5,398,437 to Elmer R. Bump, Jr. relates to a warning device for vehicles and the like. The described warning device for vehicles and the like includes a warning device for vehicles that are stopped whereby there may be danger of collision with another moving vehicle and danger of personal injury of such a moving vehicle. The present invention relates to a safety banner device for use in combination with a vehicle or the elements of nature. The safety banner device according to this invention would contain: a) foldable material; b) at least one magnet embedded in the light weight material thereby allowing the material to be affixed to a metal surface; c) at least one warning symbol made of a reflective material whereby being visible to people when lights would shine on the banner, and, wherein d) the banner is capable of being folded up several times or rolled up whereby it is capable of being stored into a small container.

### BRIEF SUMMARY OF THE INVENTION

In view of the foregoing disadvantages inherent in the known signs art, the present disclosure provides a novel apparatus for signaling a roadside emergency. The general purpose of the present disclosure, which will be described subsequently in greater detail, is to provide a safety and warning device for signaling drivers and others to improve safety.

An apparatus for signaling a roadside emergency is disclosed herein. The apparatus for signaling a roadside emergency includes a plurality of panels including a first-panel, a second-panel, and a third-panel, a plurality of markings, and a plurality of attachment means. The plurality of panels each have an elongate member having a first-side and a second-side. The plurality of panels is tri-foldable. The first-panel, the second-panel, and the third-panel are hingedly coupled in a series respectively. The plurality of markings are disposed about a surface area of the elongate member and configured to provide a visual indicator. One of the plurality of attachment means are located on a left-portion of each the elongate member and another of the plurality of attachment means located on a right-portion of each the elongate member. The plurality of attachment means is configured to attach the elongate member to a vehicle. The apparatus is configured to signal the roadside emergency.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an apparatus for signaling a roadside emergency, constructed and operative according to the teachings of the present disclosure.

FIG. 1 is a perspective view of the apparatus for signaling a roadside emergency during an ‘in-use’ condition, according to an embodiment of the disclosure.

FIG. 2 is a perspective view of the apparatus for signaling a roadside emergency of FIG. 1, according to an embodiment of the present disclosure.

FIG. 3A is a perspective view of the apparatus for signaling a roadside emergency of FIG. 1, according to an embodiment of the present disclosure.

FIG. 3B is a perspective view of the apparatus for signaling a roadside emergency of FIG. 1, according to an embodiment of the present disclosure.

FIG. 3C is a perspective view of the apparatus for signaling a roadside emergency of FIG. 1, according to an embodiment of the present disclosure.

FIG. 4 is a perspective view of the apparatus for signaling a roadside emergency of FIG. 1, according to an embodiment of the present disclosure.

FIG. 5 is a perspective view of the apparatus for signaling a roadside emergency of FIG. 1, according to an embodiment of the present disclosure.

FIG. 6A is a perspective view of the apparatus for signaling a roadside emergency of FIG. 1, according to an embodiment of the present disclosure.

FIG. 6B is a perspective view of the apparatus for signaling a roadside emergency of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to signs and banners and more particularly to an apparatus for signaling a roadside emergency as used to improve warning signs and methods of warning other drivers with signs or banners.

Generally, the present invention is a device which may be stored locally in a personal or professional vehicle. The banner may be pre-printed on two sides in high visibility contrasting reflectivity. One side reads “Caution”, to be left on the traffic facing side of the vehicle, with the other side reading “Help” if the driver and occupants are remaining near the vehicle. The driver/passenger can apply to vehicle in low light or virtually any other road conditions to improve visibility to oncoming traffic. Additionally, first responders will attend the scene faster and reduce the chance of failing to find the stranded vehicle/motorists. This device may be magnetic.

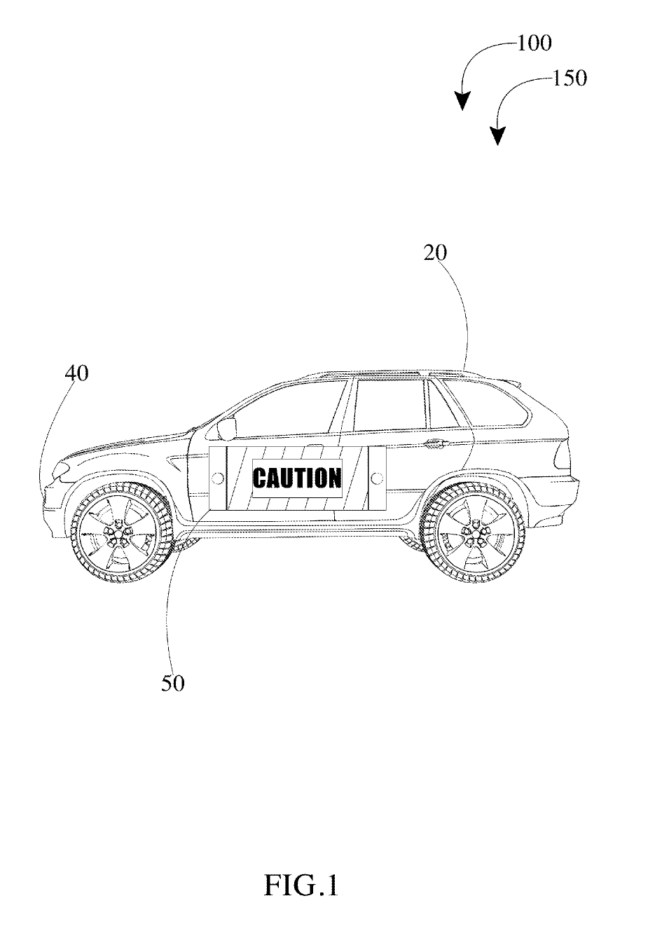

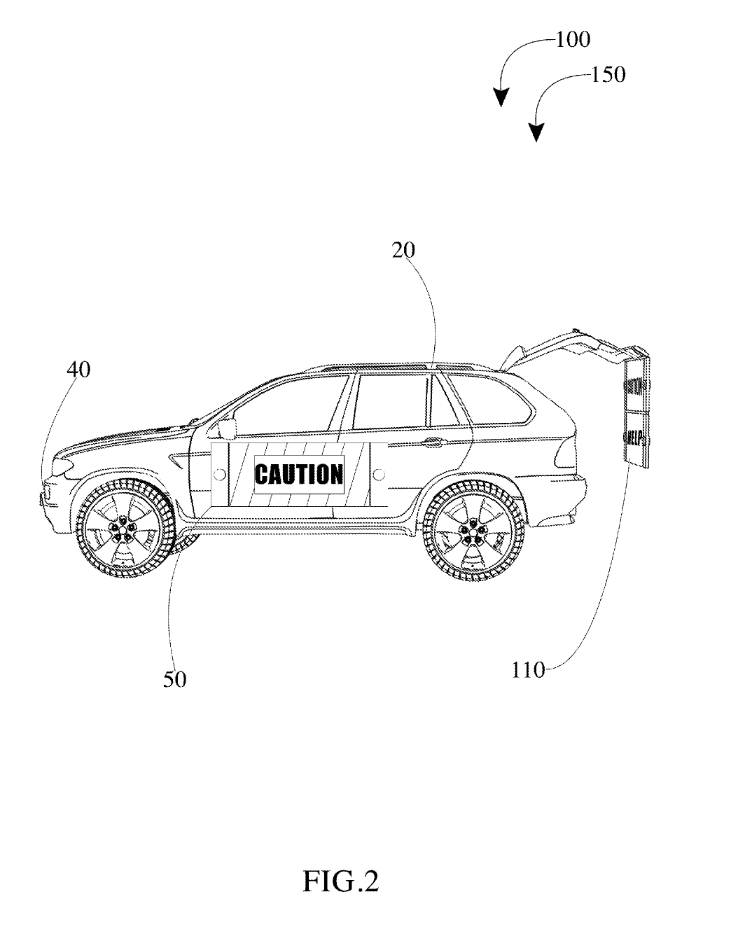

Referring now more specifically to the drawings by numerals of reference, there is shown in FIGS. 1-6B, various views of an apparatus for signaling a roadside emergency 100. FIGS. 1-2 show an apparatus for signaling a roadside emergency 100 during an ‘in-use’ condition 150, according to an embodiment of the present disclosure. As illustrated, the apparatus for signaling a roadside emergency 100 may include a plurality of panels 110 including a first-panel 120, a second-panel 124, and a third-panel 128, a plurality of markings 140, and a plurality of attachment means 160. The plurality of panels 110 each have an elongate member 168 having a first-side and a second-side. The plurality of markings 140 are disposed about a surface area of the elongate member 168 and configured to provide a visual indicator. One of the plurality of attachment means 160 are located on a left-portion of each the elongate members 168 and another of the plurality of attachment means 160 located on a right-portion of each the elongate members 168. The plurality of attachment means 160 is configured to attach the elongate member 168 to a vehicle 20. The apparatus is configured to signal the roadside emergency.

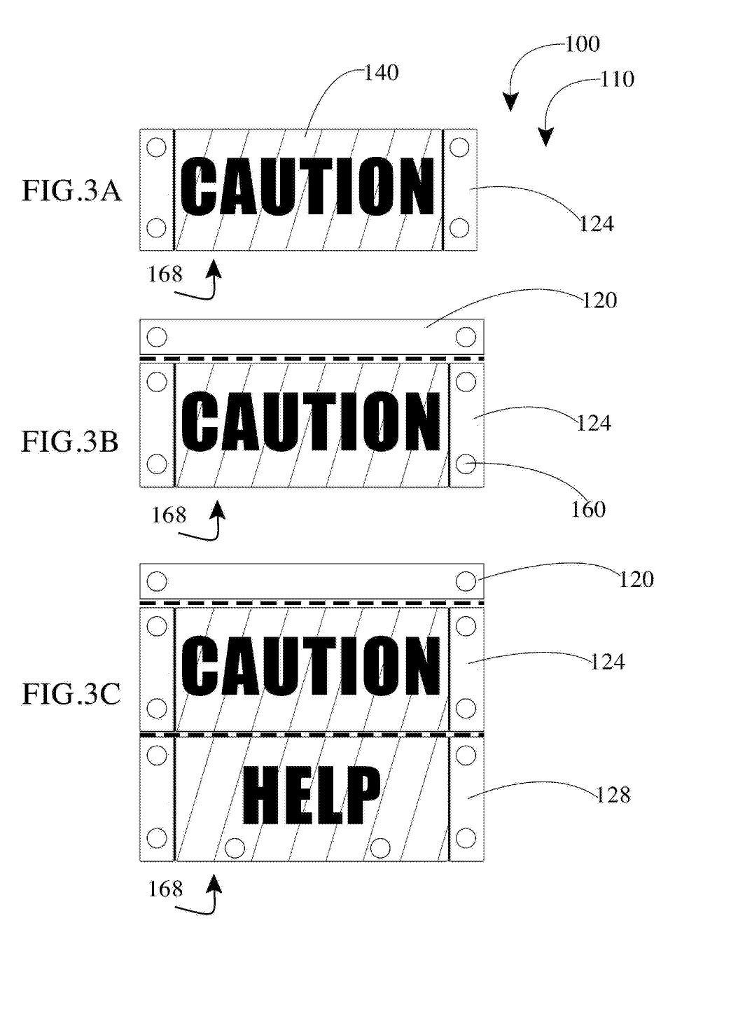

FIGS. 3A, 3B, and 3C show views of the apparatus for signaling a roadside emergency 100 of FIG. 1, according to an embodiment of the present disclosure. As above, the apparatus for signaling a roadside emergency 100 may include the plurality of panels 110 including the first-panel 120, the second-panel 124, and the third-panel 128, the plurality of markings 140, and the plurality of attachment means 160. The apparatus 100 is a safety sign or a banner. The apparatus 100 is configured to be placed on a surface of the vehicle 20 to allow oncoming traffic to see the vehicle 20. The surface of the vehicle 20 may include a back side 30, a front side 40, a left-side 50, and a right-side 60 of the vehicle 20 to allow oncoming traffic to see the vehicle 20. The elongate member 168 is made of a reflective material to allow visibility of the elongate member 168 at night.

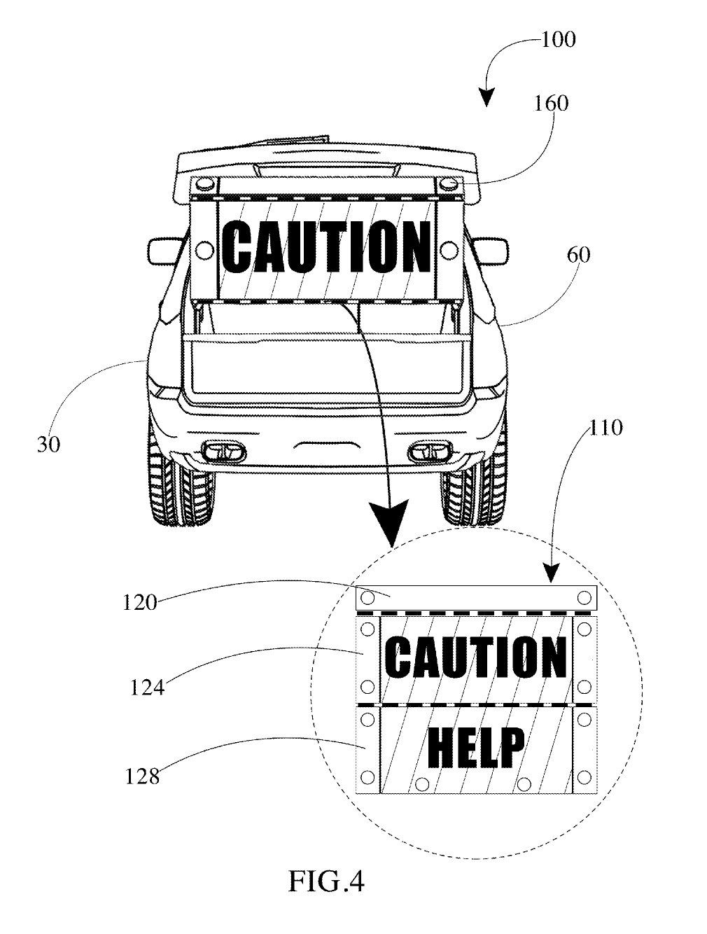

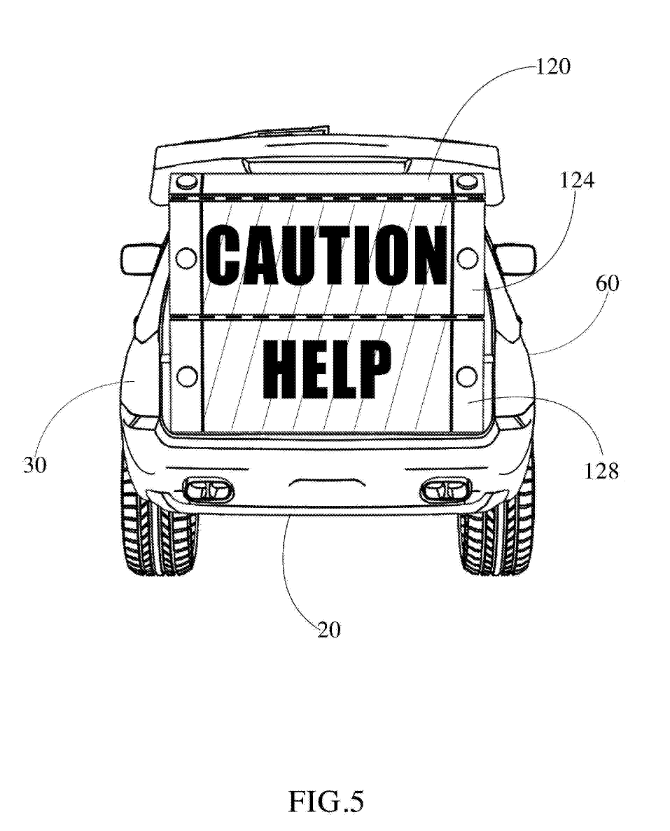

FIGS. 4-5 show perspective views of the apparatus for signaling a roadside emergency 100 of FIG. 1, according to an embodiment of the present disclosure. As above, the apparatus for signaling a roadside emergency 100 may include the plurality of panels 110 including the first-panel 120, the second-panel 124, and the third-panel 128, the plurality of markings 140, and the plurality of attachment means 160. The first-panel 120 does not comprise functional indicia. The second-panel 124 includes a first-word, “caution” acting in a capacity of functional indicia. The third-panel 128 includes a second-word, “help” acting in a capacity of functional indicia. The plurality of attachment means 160 includes a plurality of magnets. The plurality of markings 140 comprises a plurality of reflective lines.

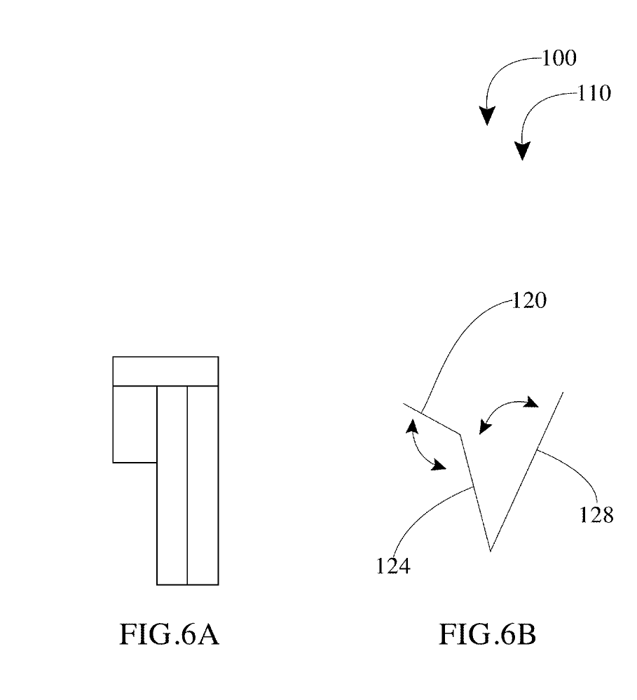

FIGS. 6A-6B shows views of the apparatus for signaling a roadside emergency 100 of FIG. 1, including the plurality of panels 110 including the first-panel 120, the second-panel 124, and the third-panel 128. The plurality of panels 110 are tri-foldable as shown in FIGS. 6A-6B. The first-panel 120, the second-panel 124, and the third-panel 128 are hingedly coupled in a series respectively. The plurality of panels 110 may be folded into a compact state and alternatively be folded to display a selected one of the plurality of panels 110.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A vehicle with an apparatus for signaling a roadside emergency comprising: a plurality of panels including;
a first-panel;
a second-panel connected to the first-panel; and
a third-panel connected to the second-panel;
a plurality of markings; and
a plurality of attachment means;
wherein said plurality of panels each have an elongate member having a first-side and a second-side:
wherein said first-panel, said second-panel, and said third-panel are hingedly coupled in a series respectively;
wherein said plurality of markings are disposed about a surface area of said elongate member and configured to provide a visual indicator;
wherein one of said plurality of attachment means are located on a left-portion of each said elongate member and another of said plurality of attachment means located on a right-portion of each said elongate member;
wherein said plurality of attachment means is configured to attach said elongate member to the vehicle; and
wherein said apparatus is configured to signal said roadside emergency.

2. The vehicle of claim 1, wherein said apparatus is a safety sign.

3. The vehicle of claim 1, wherein said apparatus is a banner.

4. The vehicle of claim 1, wherein said apparatus is configured to be placed on a surface of said vehicle to allow oncoming traffic to see said vehicle.

5. The vehicle of claim 1, wherein said second-panel includes a first-word acting in a capacity of functional indicia.

6. The vehicle of claim 1, wherein said third-panel includes a second-word acting in a capacity of functional indicia.

7. The vehicle of claim 5. wherein said first-word is caution.

8. The vehicle of claim 6, wherein said second-word is help.

9. The vehicle claim 1, wherein said plurality of panels are tri-foldable.

10. The vehicle of claim 9, wherein said plurality of panels have a length and a width, and wherein the length is greater than the width, and wherein the plurality of panels are hingedly coupled along the length of the plurality of panels.

11. The vehicle of claim 1, wherein said plurality of markings comprises a plurality of reflective lines.

12. The vehicle of claim 1, wherein said elongate member is made of a reflective material to allow visibility of said elongate member at night.

13. The vehicle claim 1, wherein said plurality of attachment means includes a plurality of magnets.

14. The vehicle claim 1, wherein said first-panel does not comprise functional indicia.

15. The vehicle of claim 4, wherein said surface of said vehicle comprises a back side of said vehicle to allow oncoming traffic to see said vehicle.

16. The vehicle of claim 4, wherein said surface of said vehicle comprises a front side of said vehicle to allow oncoming traffic to see said vehicle.

17. The vehicle of claim 4, wherein said surface of said vehicle comprises a left-side of said vehicle.

18. The vehicle of claim 4, wherein said surface of said vehicle comprises a right-side of said vehicle.

19. An apparatus for signaling a roadside emergency, said apparatus comprising: a plurality of panels including;
a first-panel;
a second-panel; and
a third-panel;
a plurality of markings; and
a plurality of attachment means;
wherein said plurality of panels each have an elongate member having a first-side and a second-side;
wherein said elongate member is made of a reflective material to allow visibility of said elongate member at night;
wherein said first-panel does not comprise functional indicia;
wherein said second-panel includes a first-word acting in a capacity of functional indicia;
wherein said first-word is caution;
wherein said third-panel includes a second-word acting in a capacity of functional indicia;
wherein said second-word is help;
wherein said plurality of panels are tri-foldable;
wherein said first-panel, said second-panel, and said third-panel are hingedly coupled in a series respectively:
wherein said plurality of markings are disposed about a surface area of said elongate member and configured to provide a visual indicator;
wherein said plurality of markings comprises a plurality of reflective lines;
wherein one of said plurality of attachment means are located on a left-portion of each said elongate member and another of said plurality of attachment means located on a right-portion of each said elongate member;
wherein said plurality of attachment means is configured to attach said elongate member to a vehicle;
wherein said plurality of attachment means includes a plurality of magnets; wherein said apparatus is configured to signal said roadside emergency; wherein said apparatus is a safety sign; and
wherein said apparatus is configured to be placed on a surface of said vehicle to allow oncoming traffic to see said vehicle.
